(19) United States
(12) Patent Application Publication
(10) Pub. No.: US 2005/0096915 A1
(43) Pub. Date: May 5, 2005

(54) Contents reproducing system and contents reproducing program

(76) Inventors: Takahiro Suzuki, Tokyo (JP); Akihiko Enamito, Kawasaki-shi (JP); Rika Hosaka, Yokohama-shi (JP); Takumi Hara, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/950,398

(22) Filed: Sep. 28, 2004

(30) Foreign Application Priority Data
Sep. 30, 2003 (JP) 2003-342540

(51) Int. Cl. G11B 5/09

(52) U.S. Cl. 704/278

(57) ABSTRACT

A contents reproducing system includes a unit which acquires contents data, a specifying unit which specifies a space transfer function that reflects a state of a space in which sound data contained in the contents data is reproduced, a generating unit which generates control sound data based on the sound data contained in the contents data and the specified space transfer function, and an output unit which outputs the sound data and the control sound data to speakers which are different from each other, respectively.

### CROSS-REFERENCE TO RELATED APPLICATIONS

This application is based upon and claims the benefit of priority from prior Japanese Patent Application No. 2003-342540, filed Sep. 30, 2003, the entire contents of which are incorporated herein by reference.

### BACKGROUND OF THE INVENTION

1. Field of the Invention

The present invention relates to a contents reproducing system and a contents reproducing program for, when reproducing viewing contents in an arbitrary place, controlling the place and a sound field state at the periphery of the place, thereby making it possible to view comfortable contents.

2. Description of the Related Art

In the case where a user views contents which include a sound, in general, a headphone or the like is used in a viewing place in which a volume cannot be increased. In such a viewing format, there is an advantage that no sound is discharged at the periphery of the place. However, on the other hand, there occurs a disadvantage that insufficient characteristics are obtained, and an adverse effect on a hearing sense is concerned.

At general home or the like, an action for a user to view contents which include a sound is an ordinary event. As seen in recent home cinema associated products, it has been more popular to reproduce a real, natural sound at home. On the other, in apartment house, there is a rare case in which a conventional concrete wall is hardly employed, and there is a tendency that a lightweight wall on which a sound is easily transmitted is used. Although a sound demanded at general home is thus more realistic and natural, there is a circumstance that a sound is easily transmitted in the neighborhood in a housing environment.

In the meantime, an active muffling technique is known as means for reducing a sound in a place other than a viewing space (refer to Precision Engineering Laboratory, Tokyo Institute of Technology, Authorized by Kiyohiko UMEZAWA, “Muffling Engineering for Comfortable Space”, Issued by KAIHATSUSHA, ISBN4-7591-00954, pages 103 to 129, the entire contents of which are incorporated herein by reference). FIG. 1 is a schematic view illustrating an overview of such an active muffling technique. In FIG. 1, when a noise 121 is discharged through a duct 122, a construction for reducing (muffling) the noise is shown. The noise 121 is collected by a reference microphone 123. In addition, a sound (control sound) in a reverse phase for eliminating the noise 121 is produced by a control device 124, and the produced sound is discharged from a speaker 125. In this manner, a sound produced by eliminating the noise 121 and the control sound from each other is collected by a control microphone 126, and a reduced sound 127 is discharged from the duct 122 to the outside while correction of the control sound is properly made by the control device 124. By providing such a construction, the noise 121 can be prevented from being discharged from the duct 122 as it is.

As described above, there is a demand for providing means capable of effectively preventing discharge of a sound to the outside of a viewing space without using a headphone when the user views contents which include the sound. In addition, although an active muffling technique of preventing noise discharge is known, an expensive system for generally carrying out active muffling is required to apply this technique to a viewing space of contents, and it is difficult for a general user to easily employ this system.

### BRIEF SUMMARY OF THE INVENTION

It is an object of the present invention to provide a contents reproducing system and a contents reproducing program for, when reproducing viewing contents in an arbitrary place, controlling the place and a sound field state at the periphery of the place, thereby making it possible to view comfortable contents.

A contents reproducing system according to one aspect of the present invention comprises: a unit which acquires contents data; a specifying unit which specifies a space transfer function that reflects a state of a space in which sound data contained in the contents data is reproduced; a generating unit which generates control sound data based on the sound data contained in the contents data and the specified space transfer function; and an output unit which outputs the sound data and the control sound data to speakers which are different from each other, respectively.

Note that the invention is also approved as, in addition to the invention of the system (apparatus, device, etc.), an invention of a method executed by the unit or a program for executing the method.

### BRIEF DESCRIPTION OF THE SEVERAL VIEWS OF THE DRAWING

FIG. 1 is a schematic view illustrating an over-view of an active muffling technique;

FIG. 2 is a schematic view showing an overview of a contents reproducing system according to the present invention;

FIG. 3 is a schematic view showing a variety of aspects of an information processing device;

FIG. 4 is a block diagram depicting a schematic construction of an information terminal;

FIG. 5 is a block diagram depicting a schematic construction of a media player;

FIG. 6 is a flow chart relating to processing of a contents reproducing system according to a first embodiment of the present invention;

FIG. 7 is a flow chart showing processing for computing a space transfer function by using a test sound (for example, a white noise);

FIG. 8 is a flow chart showing processing for estimating a space transfer function from speaker characteristics, a layout of the space and the like;

FIG. 9 is a flow chart relating to processing of a contents reproducing system according to a second embodiment of the present invention;

FIG. 10 is a flow chart relating to processing of updating a space transfer function table;

FIG. 11 is a schematic view showing an overview of a contents reproducing system according to a third embodiment of the present invention; and

FIG. 12 is a flow chart relating to processing of the contents reproducing system according to the third embodiment.

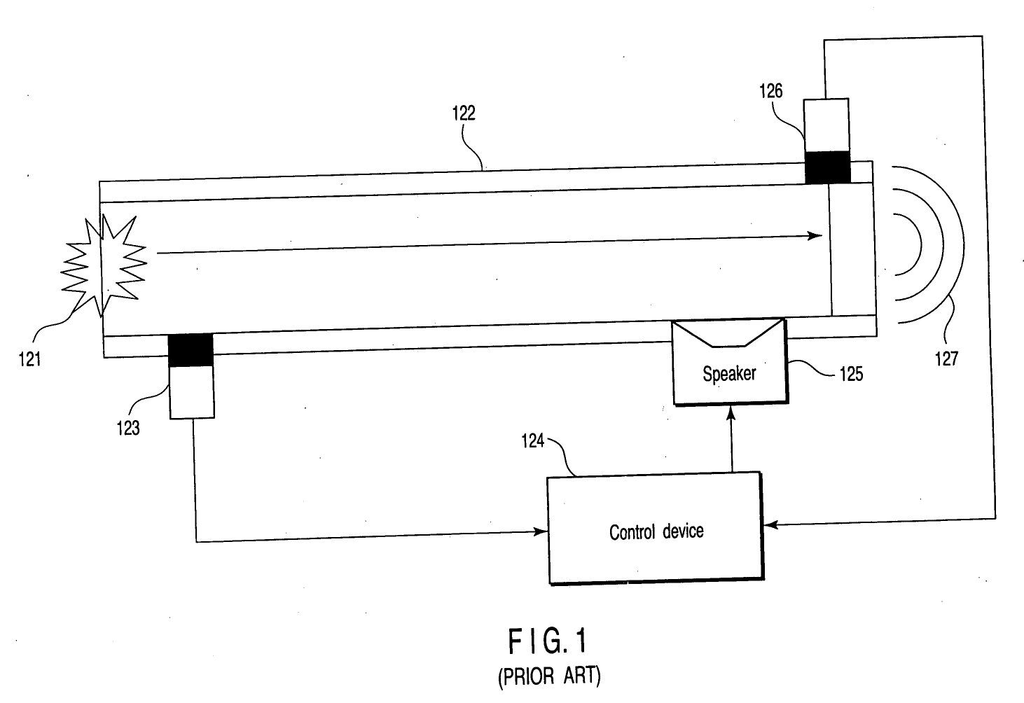

### DETAILED DESCRIPTION OF THE INVENTION

Hereinafter, embodiments of the present invention will be described in detail with reference to the accompanying drawings.

In the present invention, the term “Contents” designates information useful to a general user, for example, music or cinema. It designates what is electrically digitized and processed by an information processing device. Contents are obtained via a communication line such as Internet or are provided by a portable recording medium such as a compact disk (CD) or a digital versatile disk (DVD) having recorded electrically digitized information. These contents are electrically digitized in accordance with their specific rules. The contents can be easily reproduced by a personal information terminal or a media player by obtaining hardware, a program or the like for reproducing the contents.

In addition, “contents data” may be provided as a file. For example, the “contents data” may be provided as a compressed file in accordance with an MP3 or MPEG scheme etc. or may be provided as a non-compressed file such as WAVE. Further, the “contents data” may be provided as a file containing only a sound or may contain image data (a motion image or a still image) and the like.

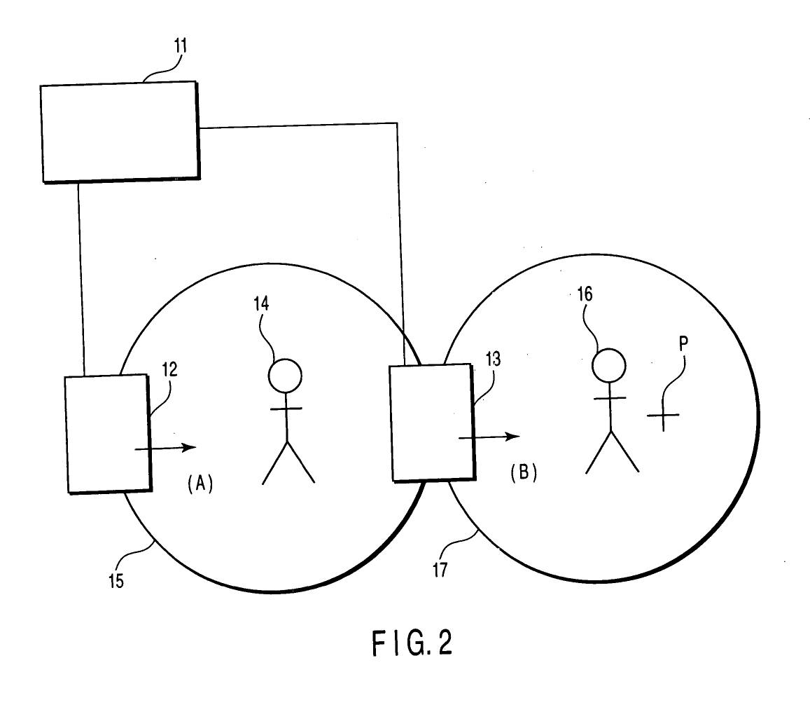

An overview of a contents reproducing system according to the present invention will be described with reference to FIG. 2.

FIG. 2 is a schematic view showing an overview of a contents reproducing system according to the present invention. The contents reproducing system according to the present invention is directed to a system to which an active muffling technique is applied, the system comprising: an information processing device 11 for reproducing contents; a speaker 12 for generating a reproduction sound of contents (hereinafter, referred to as a “contents sound”); and a speaker 13 for generating a control sound for muffling or reducing the contents sound.

The information processing device 11 includes: an information terminal such as a personal computer or a PDA which can obtain contents via a network; and a media player capable of reproducing a portable recording medium. This information processing device is capable of instructing sound generation to separate speakers 12, 13.

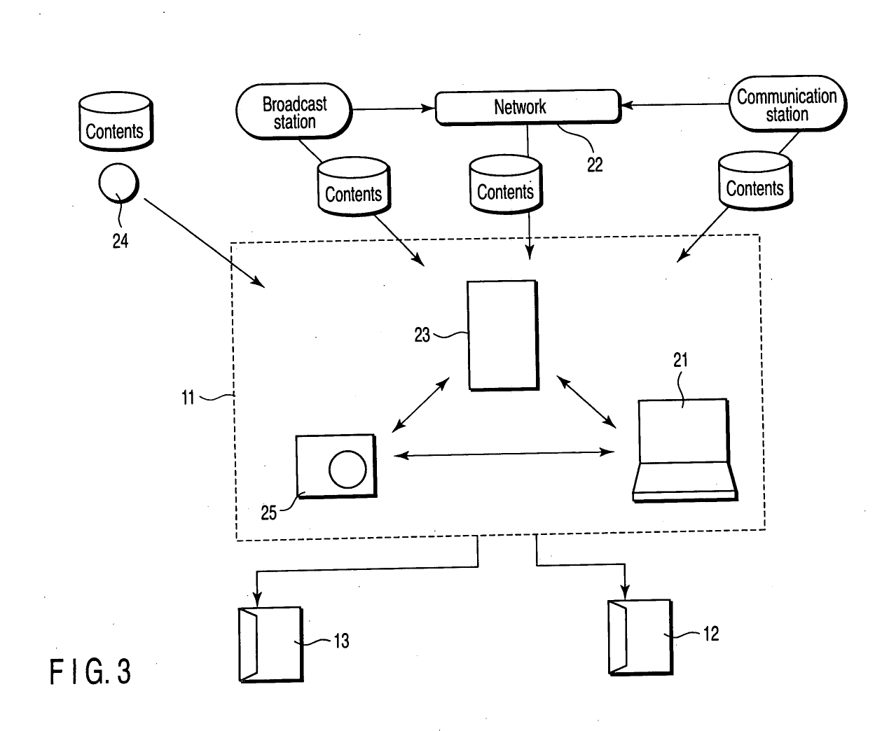

FIG. 3 shows a variety of aspects of the information processing device 11. A first aspect of the information processing device 11 is an information terminal 21 such as a PC or PDA. The information terminal 21 is directly connected to a network 22 such as Internet or is connected via a home server 23 or the like. This information terminal can obtain contents originated from a broadcast station or a communication state. In addition, when the information terminal 21 is capable of reproducing a recording medium 24 such as a CD or DVD, contents can be obtained from the recording medium 24 by the information terminal 21. Further, a second aspect of the information processing device is a media player 25 capable of reproducing the recording medium 24 such as a CD or DVD. The information terminal 21 or media player 25 is directly connected to the speakers 12, 13 or can reproduce contents via the home server 23. The home server 23 may function as an information processing device or another digital television or the like may be used as an information processing device. Hereinafter, a schematic construction of the information terminal 21 and medium player 25 will be described by way of example.

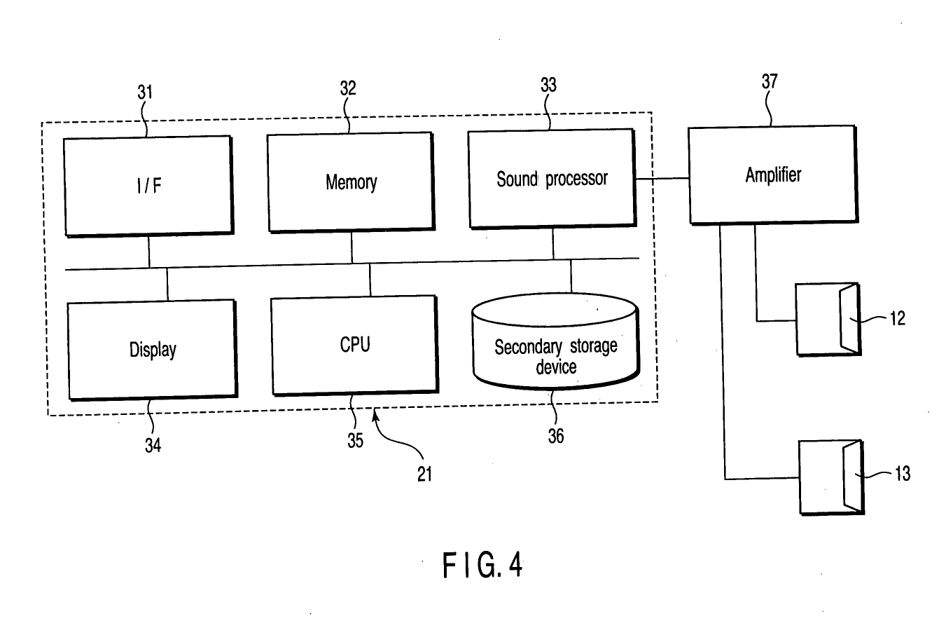

FIG. 4 is a block diagram depicting a schematic construction of the information terminal 21. The information terminal 21, as shown in FIG. 21, comprises an interface (I/F) 31, a memory 32, a sound processor (a sound card available) 33, a display 34, a CPU 35, and a secondary storage device 36 such as an HDD. To the sound processor 33, speakers 12, 13 are connected respectively via an amplifier 37. In the case of a construction for carrying out measurement of a space transfer function described later, a microphone (not shown) may be connected to the sound processor.

The sound processor 33 corresponds to a reproducing unit for reproducing sound data under the control of the CPU 35 and outputting an analog or digital echo signal. In the present embodiment, the sound processor 33 reproduces contents data; supplies the resultant contents sound to the speaker 12 for reproducing contents; and supplies a control sound described later to the speaker 13. The sound processor 33 reproduces test sound data described later and supplies the resultant test sound to the speakers 12, 13. In this manner, the speakers 12, 13 generate a sound according to each of the resultant test sounds. The record sound collected by the microphones is delivered to the sound processor 33, and digital sound data is generated. Further, the information terminal 21 receives contents via the I/F 31. The received contents are transferred from the memory 32 to the secondary storage device 36 under the control of the CPU 35, and the transferred contents are stored and maintained. The I/F 31 may be directly connected to a network or may be connected to a home server or the like.

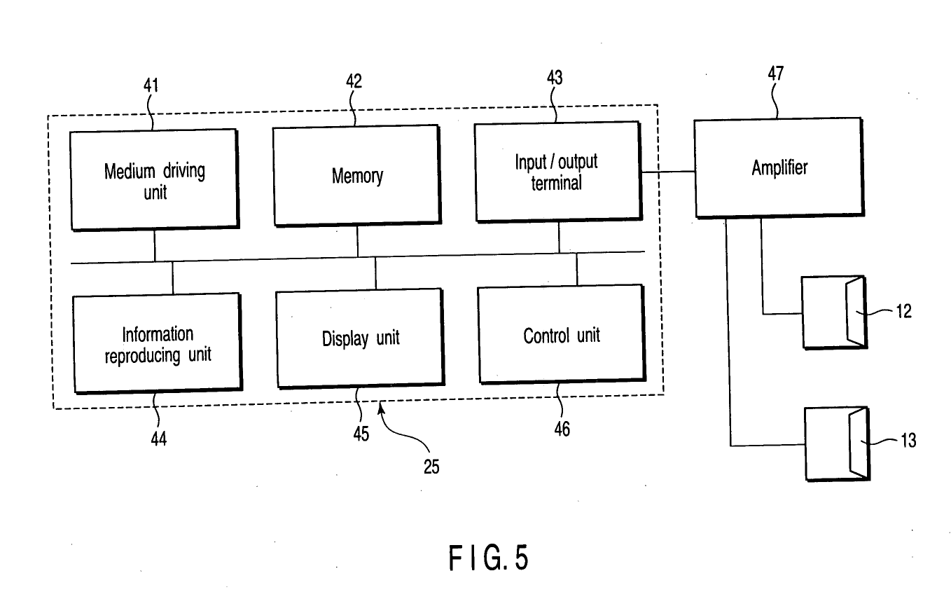

FIG. 5 is a block diagram depicting a schematic construction of the media player 25. The media player 25, as shown in FIG. 5, comprises a medium driving portion 41, a memory 42, an input/output terminal 43, an information reproducing portion 44, a display portion 45, and a control portion 46. To the input/output terminal 43, the speakers 12, 13 are connected respectively via an amplifier 47. In the case of a construction for carrying out measurement of a space transfer function described later, a microphone (not shown) may be connected to the input/output terminal 43.

A recording medium such as a CD or DVD is driven by the medium driving portion 41, and contents are reproduced by the information reproducing portion 44 under the control of the control portion 46. The resultant contents sound is supplied to the speaker 12 for reproducing contents, and a control sound described later is supplied to the speaker 13. In addition, the information reproducing portion 44 reproduces test sound data described later, and supplies the resultant test sound to the speakers 12, 13. In this manner, the speakers 12, 13 generate the sound according to each of the test sounds. In addition, the record sound collected by the microphone is transferred to the memory 32 under the control of the control portion 46, and the transferred sound is maintained. The media player 25 is connected to a home sever or the like via the input/output terminal 43.

As described above, when contents are reproduced by the information processing device 11, a contents sound is generated from the speaker 12, and a control sound which muffles or reduces the contents sound is generated from the speaker 13. As shown in FIG. 2, by reproducing a contents sound (A) and a control sound (B) of the obtained viewing contents, the contents sound (A) can be viewed in a viewing space 15 in which a viewer 14 exists. In addition, in a muffling space 17 in which a non-viewer 16 exists, the contents sound is restricted to an extent such that it does not become an obstacle. The muffling used here, as described above, includes that the contents sound is restricted (reduced) to an extent such that it does not become an obstacle to such non-viewer. Therefore, the “muffling” may reduce only a specific frequency region of a contents sound, for example.

In the above-described construction, the control sound (B) is generated based on the contents sound (A), the speakers 12, 13, and a relationship between control points P. For example, a space transfer function between the speaker 12 and the speaker 13 is subjected to a convolution integral processing for the contents sound, whereby, for example, a control sound having a reverse phase can be generated with respect to the contents sound. Such contents sound (A) and control sound (B) are reproduced after synchronized with each other at a predetermined timing. When both of the contents sound (A) and control sound (B) are superimposed, a desired muffling effect can be obtained in the vicinity of a control point P in the muffling space 17. In the case where contents include image data, the contents sound data and image data are reproduced after synchronized with each other.

The control point P may be provided in plurality in the muffling space or may be set in the vicinity of a muffling space in a viewing space.

In the following description, means for generating a control sound is described by way of example showing a case in which a space transfer function is subjected to a convolution integral processing for a contents sound. The present invention is not limited to this case, and a control sound may be generated by using another means.

Now, a method for specifying a space transfer function will be described here. The space transfer function is specified by measurement or estimation as follows.

When the space transfer function is specified by measurement, the information processing device 11 generates an inspection noise (for example, a white noise) from the speaker 12, and records the test sound at the above-described control point P. Then, this information processing device 11 generates a similar test sound from the speaker 13, and records a test sound at the control point P similarly. By the above-described record sound, an impulse response function which is a space transition function can be obtained. A specific method of computing a space transfer function is publicly known, and is described in, for example, the aforementioned reference. Even if a test sound is recorded in advance in a memory or the like in the information processing device, such test sound is not obtained from the outside via a network.

Without carrying out measurement using the above-described test sound, a space transfer function can be estimated from type, allocation, and characteristics (hereinafter, referred to as “characteristics”) of the speakers 12, 13, a layout of the space, and the like. Specifically, a space transfer function based on a variety of space layouts or speaker characteristics can be obtained in advance by actual measurement or simulation, and a desired space layout or the like is selected. In this manner, a space transfer function can be uniquely estimated at an arbitrary control point.

Embodiments of the present invention will be described below. In a first embodiment of the present invention, a description will be given with respect to a contents reproducing system and a program for carrying out estimation of a space transfer function before reproducing contents. In a second embodiment of the present invention, a description will be given with respect to a contents reproducing system and program for estimating a space transfer function and reproducing contents. In a third embodiment of the present invention, a description will be given with respect to a contents reproducing system and program for automatically re-selecting a space transfer function by triggering an output signal from a sensor or a switch installed in a viewing space or in a muffling space.

### FIRST EMBODIMENT

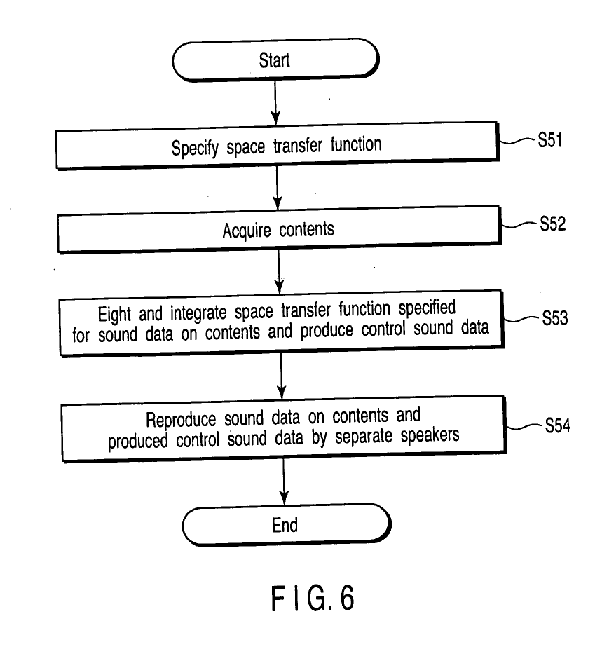

A first embodiment of the invention will be described with reference to FIGS. 6 to 8.

FIG. 6 is a flow chart relating to processing of a contents reproducing system according to the first embodiment of the invention. In the contents reproducing system according to the first embodiment, a specific transfer function is first specified in a contents viewing space or at the periphery of the space as a first step (S51).

Next, contents data is acquired (S52); and contents sound data extracted from the contents data and the specified space transfer function are subjected to a convolution integral, and control data is produced (S53). Then, the contents sound data and the control sound data are outputted to be branched respectively with respect to the separate speakers 12, 13, and the outputted data is reproduced in synchronism with each other (S54).

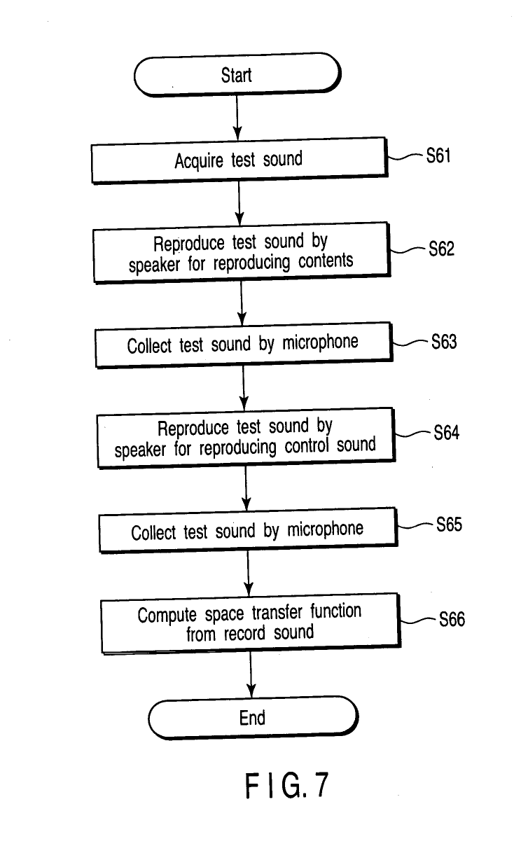

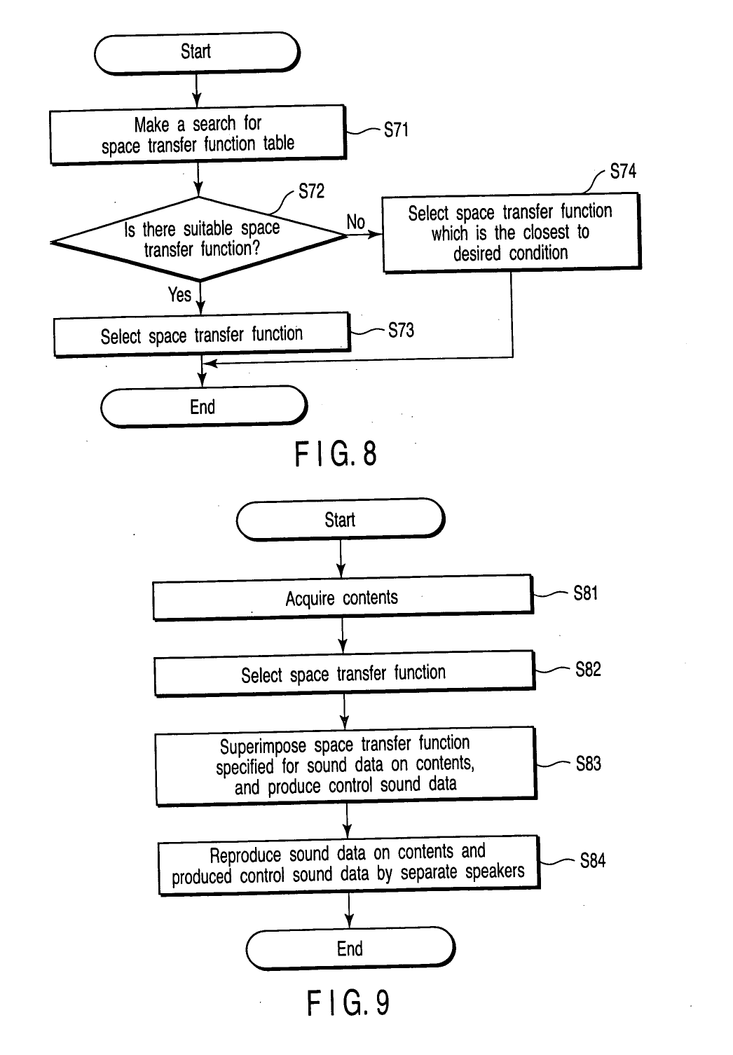

Here, processing for specifying a space transfer function will be described with reference to FIGS. 7 and 8. As described above, the space transfer function is specified by measurement or estimation. FIG. 7 is a flow chart showing processing for computing a space transfer function using a test sound (for example, white noise).

First, a test sound (for example, white noise) is acquired (S61). The acquired test sound is generated from the speaker 12 for reproducing contents (S62), and the test sound is recorded by a microphone provided at a control point (S63). Subsequently, the acquired test sound is generated from the speaker 13 for reproducing the control sound (S64), and the test sound is recorded by a microphone provided at a control point (S65). By means of the recorded sound, an impulse response function which is a space transfer function is computed (S66).

FIG. 8 is a flow chart showing processing for estimating a space transfer function from speaker characteristics, a layout of the space, and the like. In this case, a space transfer function table obtained by actual measurement or simulation for each of a plurality of control points is provided in advance based on a plurality of space layouts which are assumed to be the speaker characteristics. Such a space transfer function table may be properly downloaded from a supply source or associate site of the contents reproducing system or contents reproducing program according to the present invention via a network such as Internet, for example, or data recorded in advance in a portable recording medium may be used.

First, information concerning the characteristics of speakers actually used, a space layout, a control point and the like is inputted by using a GUI or the like provided as accessories in a system, and a search is made for the space transfer function table based on such information (S71). Then, it is determined whether or not a suitable space transfer function table exists (S72). If it is affirmatively determined, that space transfer function is selected (S73), and processing is terminated. On the other hand, when it is negatively determined, a space transfer function which is the closest to a desired condition is selected (S74), and processing is terminated. In this case, if there is no suitable space transfer function table, the current processing may be changed to processing for measuring the above-described space transfer function.

According to the present invention, such a function associated with the above processing may be achieved by hardware of an information processing device or may be provided by installing a program which causes the information processing device to execute such a function.

According to the first embodiment, there is no need for computing a space transfer function in an approximate real time and there is no need for carrying out convolution for contents data through high speed computation. Sound field control processing can be carried out by using an inexpensive information processing device. That is, even if one does not have an expensive analyzer or expertise knowledge associated with an active muffling technique, desired viewing space and muffling space can be achieved, and comfortable viewing of contents can be achieved by controlling a sound field in a space for reproducing contents.

### SECOND EMBODIMENT

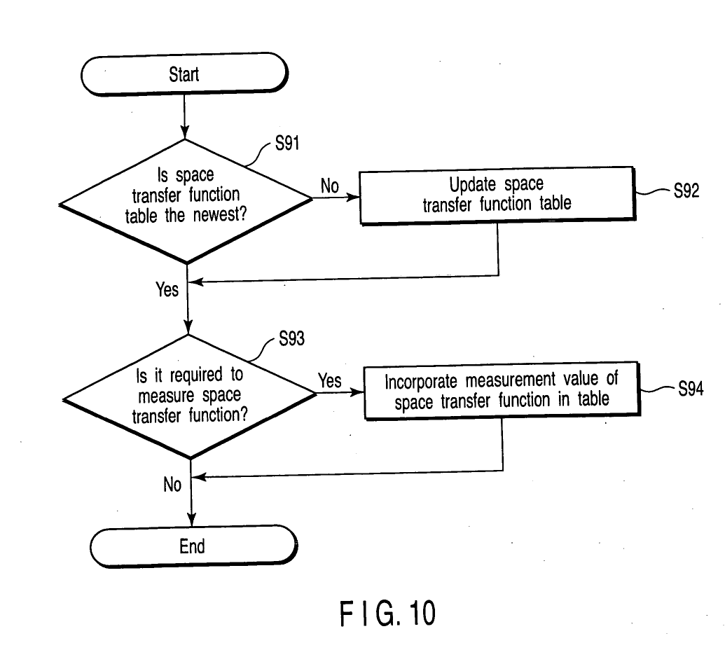

A second embodiment of the invention will be described with reference to FIGS. 9 and 10. In the second embodiment, a description will be given with respect to a contents reproducing system and program for reproducing contents by estimating a space transfer function every time contents are reproduced.

FIG. 9 is a flow chart relating to processing of a contents reproducing system according to the second embodiment of the invention. In the second embodiment, a space transfer function is allocated in advance in a table, and a viewer selects a space transfer function which is the most suitable to a space for reproducing contents, and reproduces the associated contents.

Contents are acquired (S81), and the viewer specifies a desired condition based on information associated with a space transfer function by using a GUI or the like, whereby the space transfer function is selected (S82). For example, speaker characteristics, a space layout and the like are displayed as information associated with the space transfer function (this also applies to a third embodiment described later). The subsequent processing is similar to that of the above-described first embodiment, and control sound data is produced by carrying out convolution integral of the contents sound data extracted from the acquired contents data and the selected space transfer function (S83). Then, the contents sound data and the control sound data are outputted to be branched respectively with respect to the separated speakers 12, 13, and the outputted data is reproduced in synchronism with each other (S84).

Processing of updating a space transfer function table will be described with reference to FIG. 10. FIG. 10 is a flow chart relating to processing of updating a space transfer function to be carried out before carrying out contents reproducing processing according to the second embodiment. In the second embodiment, a space transfer function table is provided in advance. First, before carrying out processing for reproducing contents, it is determined whether or not the space transfer function table is the newest (S91). When the space transfer function table is not the newest, it is updated to be the newest one (S92). Updating of the space transfer function table may be properly downloaded from a supply source or associate site of the contents reproducing system or contents reproducing program according to the present invention via a network such as Internet, for example, or alternatively, data recorded in advance in a portable recording medium may be used.

Even if the space transfer function table is the newest, it is determined whether or not measurement of a space transfer function is newly required (S93). If it is affirmatively determined, a measurement value of the space transfer function may be incorporated into a table (S94). The method described in the first embodiment may be used for measuring such a space transfer function. Processing for incorporating the measurement value of such a space transfer function into a table (S93, S94) may be omitted here.

In this way, a space transfer function table is properly updated in response to characteristics of a new speaker, a space layout and the like, whereby applicability to more various environments can be achieved and it becomes possible to broaden a possibility that an optimal space transfer function can be specified.

According to the present invention, a function associated with the above processing may be achieved by hardware of an information processing device or may be provided by installing a program which causes the information processing device to execute such a function.

According to the second embodiment, there is no need for computing a space transfer function in an approximate real time and there is no need for carrying out convolution for contents data through high speed computation. Sound field control processing can be carried out by using an inexpensive information processing device. That is, even if one does not have an expensive analyzer or expertise knowledge associated with an active muffling technique, desired viewing space and muffling space can be achieved, and comfortable viewing of contents can be achieved by controlling a sound field in a space for reproducing contents.

### THIRD EMBODIMENT

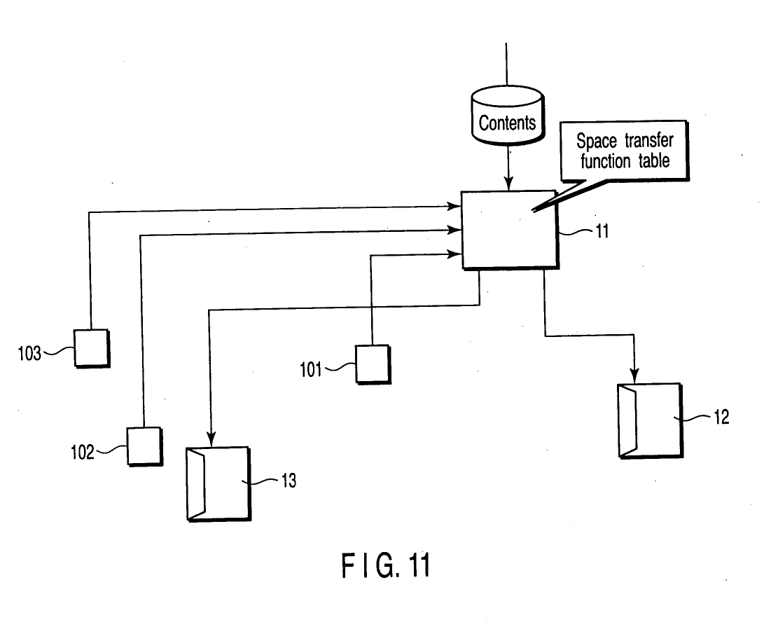

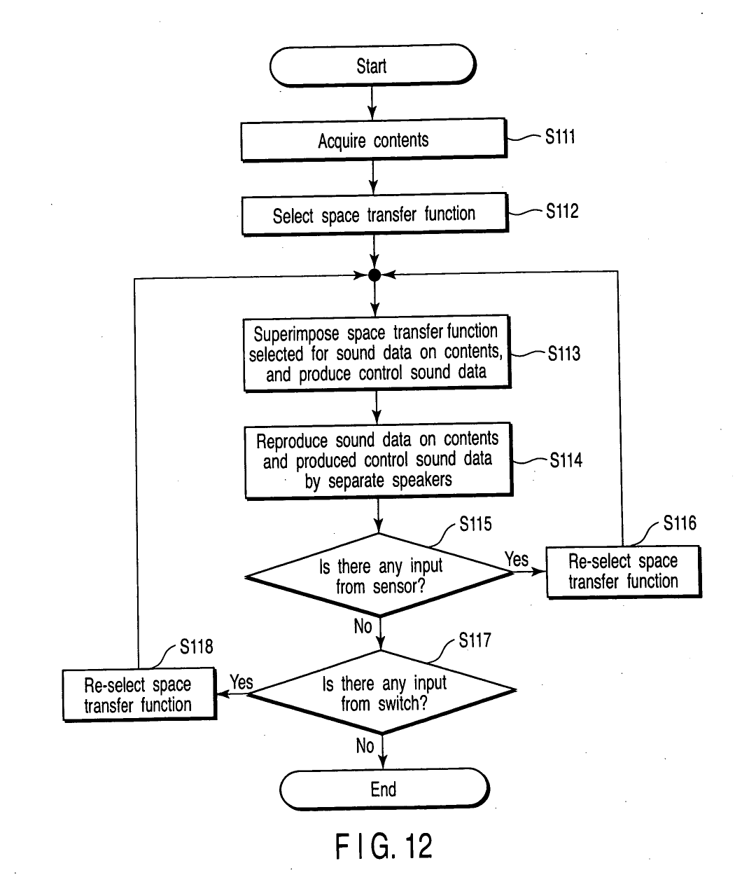

A third embodiment of the invention will be described with reference to FIGS. 11 and 12. In the third embodiment, a description will be given with respect to a contents reproducing system and program for automatically re-selecting a space transfer function by triggering an output signal of a variety of sensors or switches installed in a viewing space or a muffling space.

FIG. 11 is a schematic view showing an overview of the contents reproducing system according to the present embodiment.

Sensors 101, 102 are provided in a viewing space or a muffling space. An output signal from these sensors each is inputted to an information processing device 11. The sensors 101, 102 may be properly provided in required number or may be incorporated in the information processing device 11.

Further, an automatically or manually changeover switch 103 is provided in response to a change of a viewing space and a muffling space. An output signal from the switch is inputted to the information processing device 11. The switch 103 may be properly provided in required number or may be incorporated in the information processing device.

A speaker 12 for reproducing contents and a speaker 13 for reproducing a control sound are corrected to the information processing device 11, respectively. In this manner, contents reproducing processing can be carried out based on the second embodiment.

The information processing device 11 according to the third embodiment has a function for generating a trigger signal by an output signal of the variety of sensors 101, 102 and switch 103 each, and automatically re-selecting a space transmission space specified from a space transfer function table by means of an arbitrary trigger signal.

FIG. 12 shows a flow chart relating to processing of the contents reproducing system according to the present embodiment.

Contents are acquired (S111), and a viewer specifies a desired condition based on information associated with a space transfer function by using a GUI or the like, whereby a space transfer function is selected (S112). Contents sound data extracted from the acquired contents data and the selected space transfer function are subjected to a convolution integral, and control sound data is produced (S113). The contents sound data and control sound data are outputted to be branched respectively with respect to the separate speakers 12, 13, and the outputted data are reproduced in synchronism with each other (S114). The presence or absence of an input from the sensor is sensed during reproduction or at an interval between reproductions (S115). When the presence of the input is sensed, a space transfer function is re-selected based on an associated output signal (S116). On the other hand, the presence or absence of an input from the switch is sensed during reproduction or at an interval between reproductions (S117). When the presence of the input is sensed, a space transfer function is re-selected based on an associated output signal (S118).

Either or both of such a sensor and switch may be provided, and the above processing is properly selected and carried out according to its associated state.

Now, a variety of sensors will be described here. A variety of sensors are directed to infrared sensors. These sensors can sense an object moving in an installed space, for example, a motion of a viewer or a non-viewer. Based on an output signal of such a sensor, a proper space transfer function is re-selected in order to respond to a change of a space transfer function caused by the motion of the viewer or non-viewer, for example. Alternatively, such a variety of sensors are directed to a microphone and a voice recognition device. If a predetermined voice (or speech) is generated at a predetermined position, its contents are analyzed. A space transfer function may be re-selected upon a request of such a voice. With such a construction, it becomes possible to automatically change a viewing space and a muffling space by means of a voice (speech).

In addition, when a switch is allocated in, for example, a predetermined place in a space, and a viewer or a non-viewer has moved to such a predetermined place, the switch provided thereat is changed over, thereby making it possible to sense such a motion. Based on an output signal of such a switch, for example, a proper space transfer function is re-selected in order to respond to a change of the space transfer function caused by the motion of the viewer or non-viewer.

Although not shown, a plurality of space transfer functions are selected in advance, whereby a plurality of control sound data which superimpose these space transfer functions may be produced. In this case, based on an output signal of a sensor or a switch, predetermined control sound data may be selected from a plurality of control sound data.

According to the third embodiment, as in the first embodiment, there is no need for computing a space transfer function in an approximate real time and there is no need for carrying out superimposing for contents data through high speed computation. Sound field control processing can be carried out by using an inexpensive information processing device. That is, even if one does not have an expensive analyzer or expertise knowledge associated with an active muffling technique, desired viewing space and muffling space can be achieved, and comfortable viewing of contents can be achieved by controlling a sound field in a space for reproducing contents. Further, a space transmission space is properly re-selected in response to a state change of a viewing space and a muffling space, thereby making it possible to view contents more comfortably.

Now, a description will be given with respect to handling of the contents data and control sound data in the above-described embodiments.

For example, when an information terminal is used as an information processing device, the acquired contents data is stored in a second storage device. Then, a space transfer function is specified, and control sound data is newly produced. At this time, the contents data and control sound data may be stored as they are in separate files. However, storing these data in both of these separate files results in use of a large storage region. In addition, if the contents data and control sound data are stored in the separate files, for example, in the case where these data are transmitted to speakers via a home server, the handing of these files may be inconvenient. Therefore, in the present invention, when the contents data and control sound data are stored in the secondary storage device by using the information processing device, these data can be stored in a single file. In this case, when contents are reproduced, the contents data and control sound data are reproduced separately from such a single file. Here, when a plurality of control sound data are produced from one item of contents data, these data may be collectively stored in a single file.

Further, in the case where the control sound data is produced for the purpose of reproduction in a substantially real time during reproduction of contents, the acquired contents data and data on the specified space transfer function can be stored in advance in a single file. In this case, when contents are reproduced, the contents data and data on the specified space transfer function are read out from such a single file, and both of these data are subjected to convolution integral, whereby the control sound data is produced for the purpose of reproduction. Here, in the case where a plurality of space transfer functions have been specified for one item of contents data, these functions may be collectively stored in a single file.

Moreover, it is possible to compress the above-described file and store them as compressed files according to the user selection. When contents are reproduced, such compressed files are decompressed, and the contents data and control sound data are reproduced separately.

A storage region of an information processing device or a recording medium can be effectively utilized by carrying out such file storage.

The present invention is not limited to the above-described embodiments, and can be modified within the scope of the invention at the stage of embodiment.

According to the present invention, even if one does not have an expensive analysis device or expertise knowledge associated with an active muffling technique, desired viewing space and muffling space can be achieved, and comfortable viewing of contents can be achieved by controlling a sound field in a space for reproducing contents.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A contents reproducing system comprising:
a unit which acquires contents data;
a specifying unit which specifies a space transfer function that reflects a state of a space in which sound data contained in the contents data is reproduced;
a generating unit which generates control sound data based on the sound data contained in the contents data and the specified space transfer function; and
an output unit which outputs the sound data and the control sound data to speakers which are different from each other, respectively.

2. A contents reproducing system according to claim 1, wherein the output unit synthesizes the sound data and the control sound data with each other at a predetermined timing.

3. A contents reproducing system according to claim 1, wherein the generating unit carries out convolution integral processing of the sound data and the space transfer function.

4. A contents reproducing system according to claim 1, wherein the specifying unit specifies a plurality of space transfer functions, the generating unit generates a plurality of control sound data based on the plurality of space transfer functions, and
the output unit selects and outputs predetermined control sound data from the plurality of control sound data.

5. A contents reproducing system according to claim 1, further comprising a storage unit which stores the contents data, the control sound data or data on the space transfer function.

6. A contents reproducing system according to claim 5, wherein the storage stores the contents data and the control sound data or data on the space transfer function in a single file.

7. A contents reproducing system according to claim 6, wherein the single file is a file in accordance with a compression format.

8. A contents reproducing system according to claim 1, wherein the specifying unit acquires a space transfer function from a table in which the space transfer function is stored in advance.

9. A contents reproducing system according to claim 1, wherein the specifying unit resets the space transfer function according to an output signal from a sensor.

10. A contents reproducing system according to claim 1, wherein the specifying means resets the space transfer function according to an output signal from a switch.

11. A computer-readable contents reproducing program for controlling an information processing device as a contents reproducing system for reproducing viewing contents, the computer-readable program comprising:
acquiring processing program code for acquiring contents data;
specifying processing program code for specifying a space transfer function that reflects a state of a space in which sound data contained in the contents data is reproduced;
generating processing program code for generating control sound data based on the sound data contained in the contents data and the specified space transfer function; and
output processing program code for outputting the sound data and control sound data to speakers which are different from each other, respectively.

12. A contents reproducing program according to claim 11, wherein the output processing program code synthesizes the sound data and the control sound data with each other at a predetermined timing.

13. A contents reproducing program according to claim 11, wherein the generating processing program code carries out convolution integral processing for the sound data and the space transfer function.

14. A contents reproducing program according to claim 11, wherein the specifying processing program code specifies a plurality of space transfer functions,
the generating processing program code generates a plurality of control sound data based on the plurality of space transfer functions, and
the output processing program code selects and outputs predetermined control sound data from the plurality of control sound data.

15. A contents reproducing program according to claim 11, further comprising processing program code for causing the information processing device to function as a storage unit which stores the contents data the control sound data or data on the space transfer function.

16. A contents reproducing program according to claim 15, wherein the storage processing program code stores the contents data and the control sound data or data on the space transfer function in a single file.

17. A contents reproducing program according to claim 16, wherein the single file is a file in accordance with a compression format.

18. A contents reproducing program according to claim 11, wherein the specifying processing program code acquires a space transfer function from a table in which the space transfer function is stored in advance.

19. A contents reproducing program according to claim 11, wherein the specifying processing program code resets the space transfer function according to an output signal from a sensor.

20. A contents reproducing program according to claim 1, wherein the specifying processing program code resets the space transfer function according to an output signal from a switch.
